(19) United States
(12) Patent Application Publication
(10) Pub. No.: US 2019/0293163 A1
(43) Pub. Date: Sep. 26, 2019

(54) DRIVE SYSTEM USING BALLS WITHIN A CONDUIT FOR TRANSMISSION OF MOTIVE POWER

(71) Applicant: DISNEY ENTERPRISES, INC., Burbank, CA (US)

(72) Inventors: JEREMY ANDREW MIKA, BURBANK, CA (US); JON HAYES SNODDY, PASADENA, CA (US); SCOTT FRAZIER WATSON, MARINA DEL RAY, CA (US)

(21) Appl. No.: 16/441,128

(22) Filed: Jun. 14, 2019

Related U.S. Application Data
(62) Division of application No. 15/431,975, filed on Feb. 14, 2017.

(51) Int. Cl. F16H 49/00

(52) U.S. Cl. CPC F16H 49/00

(57) ABSTRACT

A system for transmitting motive force. The system includes a conduit or tube and a plurality of balls (e.g., spherical objects) positioned within the tube. The system includes a drive assembly moving the balls within the tube, and the system includes an actuated element operating to generate an output in response to movement of the balls within the tube. In some cases, the balls are metal ball bearings, and the tubing is one of polyethylene tubing, tubing with a metal lining, or tubing having a hardness greater than a hardness of polyethylene. The drive assembly may include a feed screw driven by a motor to provide positive displacement of the balls in the tube. The actuated element may take a variety of forms to practice the system. For example, the actuated element may be a linear or rotational actuator, e.g., an actuator used to actuate a robotic joint.

### CROSS REFERENCE TO RELATED APPLICATIONS

This application is a divisional of U.S. patent application Ser. No. 15/431,975, filed Feb. 14, 2017, which is incorporated herein by reference in its entirety.

### BACKGROUND

### 1. Field of the Description

The present description relates, in general, to drive or actuation systems for selectively actuating or driving devices such as actuators and, more particularly, to a system for transmitting motive power to an actuator or a driven device with high precision through the use of a plurality of balls (i.e., nearly any spherical object) moving through a transmission line (e.g., a conduit).

### 2. Relevant Background

There are many applications where it is desirable to actuate or drive a component or portion of a system to achieve desired movement or other results. For example, robots are used in industrial settings and in entertainment venues, and each of these robots typically has one-to-many joints. There is a need for an efficient way to actuate each of these joints, and the motor or driver for these joints often is located in a different location within the robot than the driven or actuated joint. Further adding to the design challenges is the demand for higher levels of precision in actuation to accurately represent animated emotion in the robot.

Presently, a wide variety of techniques and devices are used to actuate robotic joints (and other components of a system), but each presents design challenges for implementation that may make them inappropriate or impractical for some applications. For example, a component such as a robotic joint may be provided direct actuation with an electric motor and gearbox, which can be noisy and heavy or be too large to fit within some robot form factors. Push-pull cables with pulleys or gears have been used to actuate robotic joints in some cases, but these can be relatively complex to implement to provide a desired movement and can require significant space within the robot.

Other robots (or systems with actuated/driven components) utilize pneumatic and/or hydraulic drives including transmission lines between actuated joints and drive cylinders, but it can be difficult to precisely control actuation with air and/or gas as it can be hard to measure and control actuation as gauges and valves are needed that add to the complexity of the drive system. Gas and air-based actuation can also be relatively noisy to implement and can fail or be less effective due to leakage.

Hence, there remains a demand for an improved drive or actuation system for transmission of motive power. A new system would preferably be relatively simple to implement, small in volume relative to transmitted motive power, quiet, and suited for mounting within an enclosed space (e.g., a robot's torso) while providing precise control (which is measurable) over the amount of actuation provided for a driven/actuated element (e.g., a robotic joint).

### SUMMARY

Briefly, the inventors recognized that it may be desirable and practical to provide a new motive power transmission system that uses balls (i.e., nearly any spherical shaped object including plastic, ceramic, or metallic ball bearings) as the power medium in place of oil or gas. The balls (or ball bearings) are placed inside of a transmission line (e.g., a conduit that may take the form of flexible or rigid tubing), and the balls provide a power medium that is very controllable with simple components. For example, the system may include a drive (or drive assembly) in the form of a specially-designed screw mated to a motor, and this screw-based drive can move the balls forward and backward (in a first direction and in a second direction) within the transmission line (or tube system). Air and hydraulic fluid can be difficult to measure for actuation, but prototyping has proven that it is very easy to precisely measure how many balls are flowing through a transmission line and/or how much actuation has been provided by ball movement (e.g., movement of a measurable number of balls through the drive causes a like amount of actuation (as may be measured by the outer diameter of each ball) at the driven/actuated element).

The system further includes a driven or actuated element to convert the motive energy or power input into the balls by the drive into a desired output (e.g., a desired amount of actuation at a robotic joint in a robot). In one useful example, the actuated or driven element is provided as simple mechanisms at the opposite end of the conduit (relative to the drive) that are used to convert the input motive power or energy in the moving balls into linear or rotational motions. Many other actuated or driven elements can be used with the ball-based power transmission and are described in detail in the following description and attached figures.

More particularly, a system is provided for transmitting motive force such as to actuate a robotic joint, to move a vehicle along a track, and the like. The system includes a conduit or tube and a plurality of balls (e.g., spherical objects) positioned within the tube, with each of the balls having matching outer diameters (ODs) that are less than an inner diameter of the tube. The system also includes a drive assembly moving the balls within the tube, and the system includes an actuated element operating to generate an output in response to movement of the balls within the tube.

In some embodiments, the balls are metal ball bearings, and the tubing is one of polyethylene tubing, tubing with a metal lining, or tubing having a hardness greater than a hardness of polyethylene. In these or other embodiments, the drive assembly includes a feed screw driven by a motor to provide positive displacement of the balls through the drive assembly (e.g., at a known/metered rate). In implementing the system, a subset of the balls may be magnetic spheres, and the drive assembly may include a series of at least three coils wrapped around a section of the tube and a power source sequentially applying electricity to the coils, whereby the drive assembly operates as a linear motor to move the balls in the tube.

The actuated element may take a variety of forms to practice the system. For example, the actuated element may be a linear or rotational actuator (e.g., to actuate a robotic joint that may be included in the system or the system may be provided within a robot). When a linear actuator, the actuator may include a plunger contacting one of the balls, a rod attached at a first end to the plunger and with a second end extending out of an end cap affixed to an end of the tube, and a spring in the tube extending around the rod between the plunger and the end cap.

In other cases, the actuated element may include a magnetic coupler positioned adjacent to one of the balls, and the one of the balls and the magnetic coupler may be magnetically coupled together, whereby the magnetic coupler moves along an outer surface of the tube when the one of the balls is moved within the tube. In these cases, the one of the balls may be provided as a magnetic sphere and the magnetic coupler may include a ferrous ring extending about a periphery of the tube. Further, to assist in efficient ball movement, the balls on opposite sides of the one of the balls are non-magnetic or non-ferrous.

In some embodiments, the tube may include a slot defining a passageway from an interior space of the tube to a space exterior to the tube. Further, the slot typically will extend parallel to a longitudinal axis of the tube. The actuated element may include a body positioned between an adjacent pair of the balls within the tube and an arm attached at a first end to the body and extending through the slot to the space exterior to the tube, whereby objects coupled to the second end of the arm move along the tube with movement of the balls.

In other embodiments, the actuated element may include a coil wrapped around an exterior surface of the tube. In such embodiments, the balls may include magnetic and non-magnetic balls arranged in a pattern, whereby movement of the balls in the tube causes the magnetic field in the coil to vary over time such that data may be encoded or decoded during operations of the system. In other implementations, the actuated element may include a payload positioned within the tube between a pair of adjacent ones of the balls, and the payload may be an electronic device (such as a light source (e.g., an LED) in a spherical housing with the tube being clear or at least translucent to light), a mating mechanism, and/or a magnet.

### BRIEF DESCRIPTION OF THE DRAWINGS

FIG. 1 is a functional block diagram of a system (e.g., a motive power transmission system) that uses driven or moved balls in a conduit (or transmission line) to actuate or drive a component/element in the system (e.g., a robotic joint or other mechanism);

FIG. 2 is a sectional view a length of conduit or a transmission line carrying a set of balls providing a power transmission medium such as may be used in the system of FIG. 1;

FIGS. 3A and 3B are sectional, perspective and side exploded views of a pump device that may be used in a drive assembly of a transmission system of the present description;

FIG. 4 illustrates a side sectional view of a portion of a transmission system of the present description showing the use of a drive assembly configured as linear motor;

FIG. 5 illustrates a portion of a system, such as an implementation of the system of FIG. 1, with one embodiment of a driven/actuated element in the form of a reversible drive or linear actuator;

FIG. 6 illustrates a portion, similar to FIG. 5, of another system, e.g., another implementation of the system of FIG. 1, that includes a different embodiment of a driven/actuated element in the form of a linear actuator using magnetic coupling;

FIG. 7 illustrates a portion, similar to FIGS. 5 and 6, of yet another embodiment of a system, e.g., another implementation of the system of FIG. 1, that includes another embodiment of a driven/actuated element in the form mechanically-coupled mechanism; and

FIG. 8 illustrates a portion, similar to FIGS. 5-7, of another embodiment of a system, e.g., another implementation of the system of FIG. 1, that includes another embodiment of a driven/actuated element in the form of a data encoder/decoder.

### DETAILED DESCRIPTION

A new motive power transmission system is described that can be used in a wide variety of applications to precisely actuate a driven/actuated object. For example, the new system can be used to selectively actuate a robotic joint of a robot. Briefly, the system includes numerous balls or spherical objects contained within a transmission line (e.g., any conduit such as a flexible plastic or rubber tube, a metal pipe, and the like) and also a drive or drive assembly for selectively causing the balls to “flow” or move within the transmission line at a rate or to a certain extent to actuate or drive another element/component (such as a robotic joint, a linear or rotational actuator, or the like) in the system.

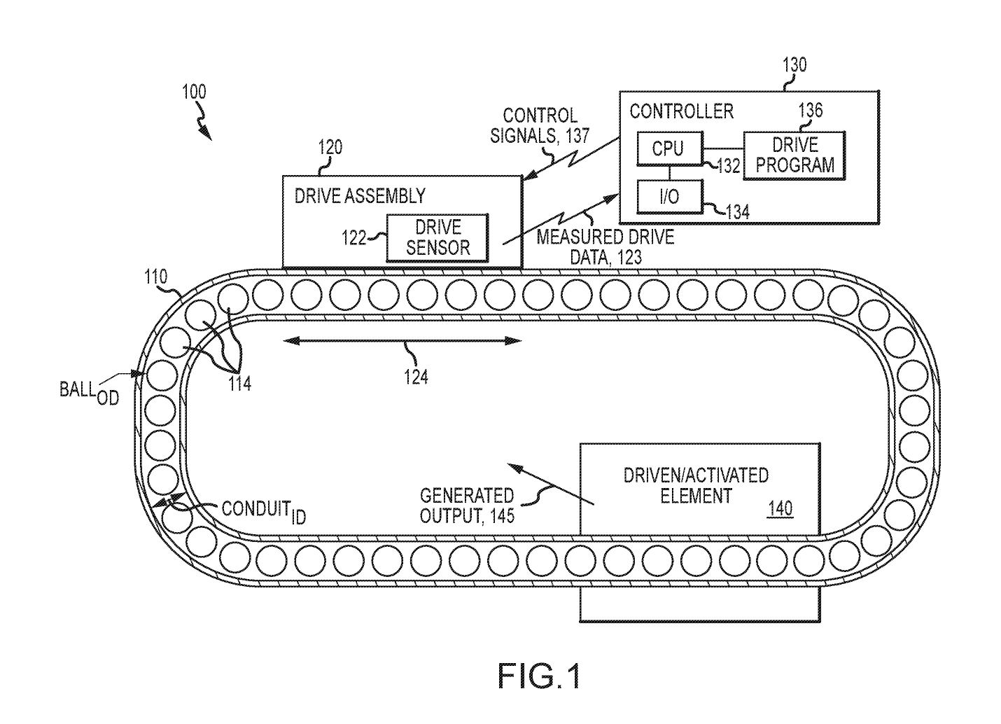

FIG. 1 is a functional block diagram of a system 100 making use of the ball-based (or spherical-object based) transmission of motive power of the present description. As shown, the system 100 includes a transmission line 110 that may take a variety of forms such as a conduit (e.g., a tube, a pipe, or the like) that is rigid (formed of a hard plastic, a ceramic, metal, or the like) or flexible (formed of a material hard enough to provide non-binding and “tough” contact surfaces such as polyethylene tubing or a softer tubing lined with a harder material such as metal as more rigid or harder walling is typically desirable for good ball flow/movement relative to the inner surfaces of the conduit 110 (note, vinyl tubing may be too soft in some applications as it may restrict flow when bent)). The transmission line may be shaped into a loop as shown or may extend between first and second ends (e.g., have a fixed length with an end near the drive assembly 120 and an end at or near the driven/actuated element 140).

The system 100 may be considered as being configured to provide ball-based transmission of motive power. To this end, the system 100 includes a plurality of balls 114 contained within the interior space of the line/conduit 110. The balls 114 may take the form of nearly any spherical objects with one prototype using metal ball bearings (or solid metal spheres). Other materials may be used for the balls 114 such as plastic, glass, ceramics, rubber, and the like, and the balls 114 do not need to be solid to practice the system 100 (e.g., may be hollow spheres with an outer wall formed of a rigid material such as metal, plastic, or the like that is configured to limit risk of deformation from ball-to-ball collisions and/or from contact with features of the drive assembly 120 or driven/actuated element 140).

The size of the balls 114 may also vary significantly to practice the system 100 such as with an outer diameter, Ball_{OD}, in the range of 0.125 to 3 inches or more. In many embodiments of the system 100, all the balls 114 may be chosen to have a single/matching outer diameter, Banco, to facilitate flow in the conduit 110 and to facilitate measuring of transmitted motive power by allowing measurement of flow/movement of balls through or by a drive assembly 120. The ball 114 is typically sized to further smooth flow around bends as well as in straight runs of the conduit 110 and, to this end, the ball's outer diameter, Ball_{OD}, typically will be some predefined amount less than the inner diameter, Conduit_{ID}, of the conduit 110 such as 5 to 20 percent less.

The system 100 includes a drive or drive assembly 120 that is adapted to selectively cause (to drive) the balls 114 to flow or move within the conduit 110 as shown with arrows 124. The flow/movement may be in one direction or alternate between movement in a first direction and movement in a second direction as shown with arrows 124 to achieve a desired driving or actuation, and the flow rate or velocity of movement 124 of the balls 114 may also be controlled by the drive assembly 120 to achieve a desired actuation/driving in the system 100.

The system 100 includes a controller 130 that operates to transmit control signals (wired or wireless communication links) 137 to the drive assembly 120 to control the movement/flow 124 of the balls 114 provided by the drive assembly 120. The control signals 137 may be generated in response to processing of measured drive data 123 (movement of balls 114 past a particular point as measured by number per time period) from a drive sensor 122 (e.g., a motor encoder or the like determining an amount of operation of the drive assembly 120 that moves a predetermined number of balls a particular distance).

The controller 130 may include a processor 132 that executes code/software to provide functionality of a drive program 136 that generates the control signals 137 to operate the drive assembly 120 to move 124 the balls 114 to achieve a desired actuation or driving of a driven/actuated element 140 (e.g., a robotic joint or other system component). For example, the actuation may be provided by movement of a predefined number of the balls 114 (based on their size, Ball_{OD}) through a pump/driver in the assembly 120 or a predefined distance by the assembly 120, and the control signals 137 are provided to provide ball movement (in one of the two directions) 124 until the measured drive data 123 by the drive sensor 122 (e.g., a motor encoder or the like) in the drive assembly 120 indicates (based on processing by the drive program 136) that the predefined number of balls 114 have been moved the predefined distance or through the component of the assembly 120. The controller 130 is shown to include input/output (I/O) devices 134 that enable the communications of the signals 123 and 137 as well allowing an operator (not shown) of the controller 130 to provide input (such as to select the drive program 136, to initiate the program 136 or a subroutine therein, to choose a component such as element 140 to actuate (and how, when, and so on), and the like).

The system 100 is shown to further include at least one driven or actuated element (or component) 140. The driven/actuated element 140 may vary to implement the system 100 but, in general, is configured to convert the motive power or energy into another form of energy or work or to include one or more components that are driven or actuated by the movement 124 of the balls 114 in the conduit 110 by the drive assembly 120 all of which is represented by the arrow 145 (e.g., any generated output). The balls 114 may actually flow through or into the driven/actuated element 140 to contact one or more members/features of the element 140 (or such members/features may extend into the interior space of the conduit 110 to allow such contact/collisions with the balls 114) to provide the actuation (such as a linear or rotational actuation) or the assembly 140 may be provided adjacent or exterior to the conduit 110 and be “driven” by passing balls 114 (e.g., a collar with magnets or coiling or the like about the conduit's outer wall). A number of examples of driven/actuated elements 140 are provided in the following description with reference to the attached figures and include linear and rotational actuation such as may be used in actuation or driving a robotic joint in a precise manner.

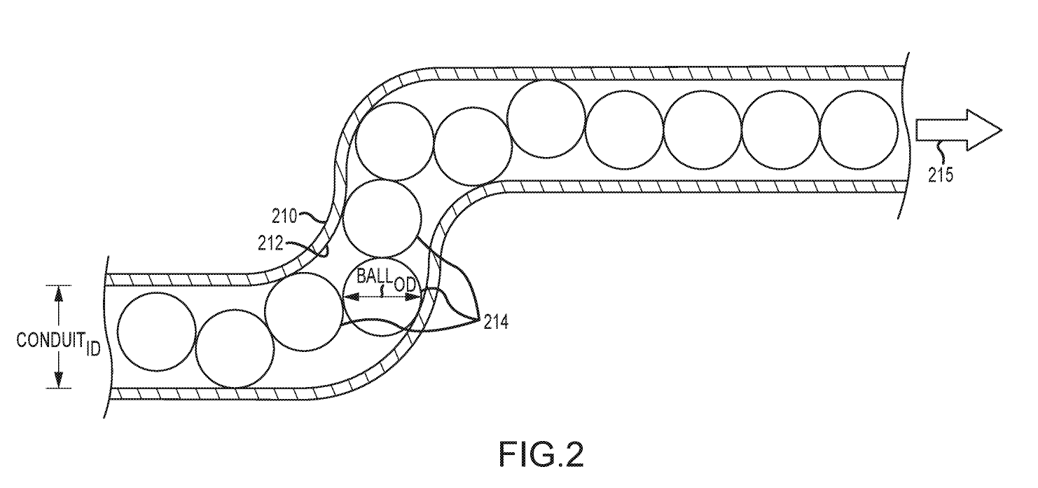

FIG. 2 illustrates a length of conduit 210 as may be used in a transmission system such as system 100 of FIG. 1, with the conduit 210 shown in sectional view to reveal its inner sidewall or contact surface 212 defining the inner diameter, Conduit_{ID}, of the conduit 210. A plurality of balls 214 such as ball bearings or the like are shown with arrow 215 to be flowing to the right (or a first direction) through the conduit 210 such as in response to being “pumped” or driven by a drive assembly (not shown in FIG. 2 but may take the form of assembly 120 of FIG. 1). In the example of FIG. 2, the balls 214 have an outer diameter, Banco, that is relatively small compared with the conduit inner diameter, Conduit_{ID} (such as with a Ball_{OD} of 55 to 80 percent of the Conduit_{ID}). Significantly, even with larger spacing from the inner sidewall/contact surface, the ball bearings 214 tend to find their way through the conduit 210 during flow/motion 215 and do not generally get bound up or clogged. This indicates that a close matching of the conduit size with the ball size is not required to practice the motive power transmission systems of the present description.

As discussed above, the drive or drive assembly used to cause the balls to flow or move in the conduit may be varied to practice a motive power transmission system. In one example, the drive assembly (e.g., assembly 120 of FIG. 1) is provided as a pneumatic system. In this example, the conduit was arranged as a non-loop length (without its two ends being connected together). The balls within the conduit/tube are propelled or driven to move by injecting pressurized air at one end of the conduit/tube (from a pressurized air supply or the like) and the injected air is vented out from the other/opposite end of the conduit/tube.

In another embodiment (which the inventors prototyped), the tubing (polyethylene) was arranged in a loop and filled with numerous metallic ball bearings. In this embodiment, the drive assembly was provided as a bearing pump and as a pump device (e.g., with a feed screw (or screw pump) attached to an electric motor (and an encoder may be used as the drive sensor 122 to determine rotations of the motor and use of the screw pump/feed screw to move “X” balls)).

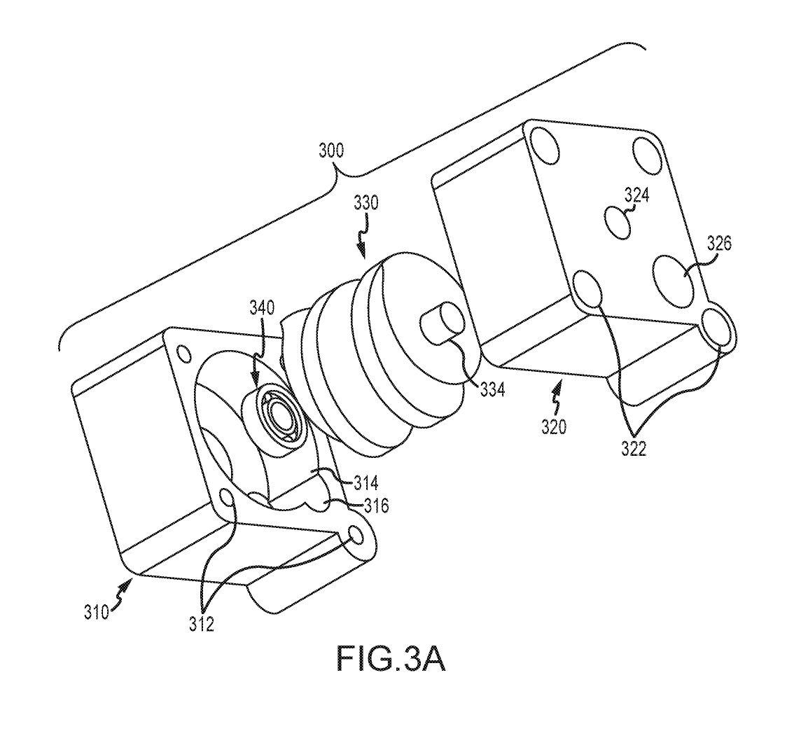

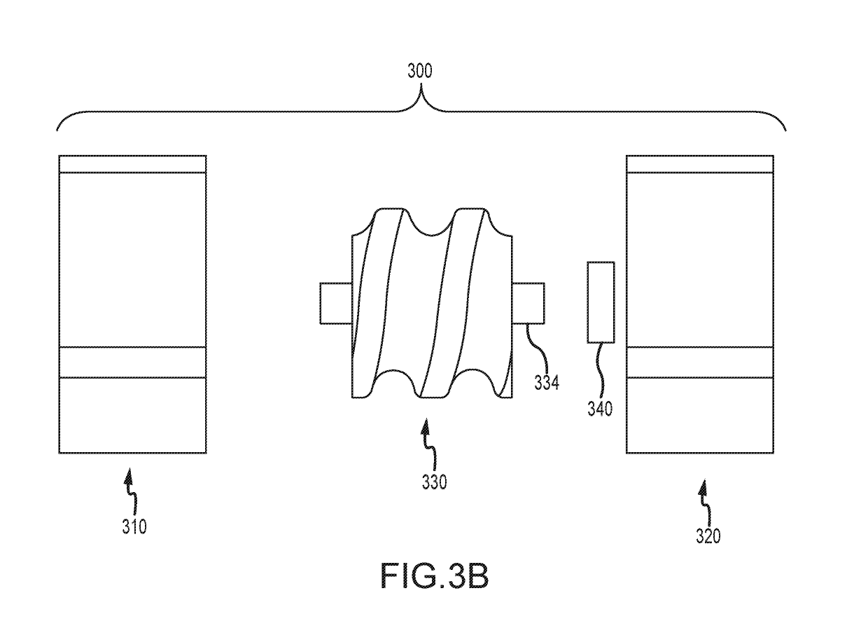

FIGS. 3A and 3B illustrate, with an exploded perspective view and a side view respectively, a pump device 300 in the form of a screw pump (or feed screw device) that can be used in a drive assembly (e.g., assembly 120 in FIG. 1) to provide a positive displacement drive of the balls in the conduit. As shown, the device 300 includes a two-part body formed with upper and lower body members 310, 320, which when assembled are mated to each other by a set of four fasteners (not shown) such as screws, bolts, or the like fit into corresponding fastener holes 312 and 322 on the body members 310 and 320. The body member 310 includes a recessed surface or cavity 314 that is cylindrical in shape for receiving a drive or feed screw 330.

The feed/drive screw 330 is driven by a shaft 334, which in use is coupled with a drive motor (not shown in FIGS. 3A and 3B), that can be rotated in either direction (CW or CCW) to move balls in either of two directions through the pump device 300, and a bearing 340 is provided to support the shaft 334 within a portion of the recessed surface/cavity 314. A passageway 316 is provided in one corner of the cavity/recessed surface 314 that along with the cylindrical passageway 326 in the body member 320 defines a path balls travel along through the pump device 300. The pump device 300 is a positive displacement pump and the passageway 316 is configured to be semicircular in cross section with an inner diameter that is about one half of the diameter of a ball, Ball_{OD}, and the threads of the drive/feed screw 330 are chosen to be semi-circular in shape with a depth of about one half of the diameter of a ball, Ball_{OD}.

The threads of the drive/feed screw 330, hence, drive the balls that engage these threads along the passageway 316, 326 to flow through a conduit coupled with the inlet/outlet of the passageways 316, 326 in body members 310, 320. The threads are chosen to have a pitch to achieve a desired amount of displacement of the balls during rotation of the screw 330 such as spinning the screw 330 two times (or a different number of times) (or through two full 360-degree rotations via shaft 334) to move one ball fully through the screw pump 300. An encoder (e.g., a drive sensor 122) may be provided to measure these rotations and provide this information to a controller to achieve a desired amount and/or rate of actuation/driving of a driven/actuated element upstream or downstream of the pump device 300 (and coupled to or proximate to the conduit containing the balls). For example, if two rotations move a ball through the pump device 300, the controller of the transmission system may operate the motor attached to the shaft 334 to rotate the screw 330 ten times to provide actuation of a robotic joint or the like with five balls (e.g., to move a linear actuator five times the ball diameter, Ball_{OD}). Note, in some cases, the screw device shown is simply used to meter out (or through) the balls, and other devices such as the pneumatic drive discussed above are used to drive the balls through the conduit.

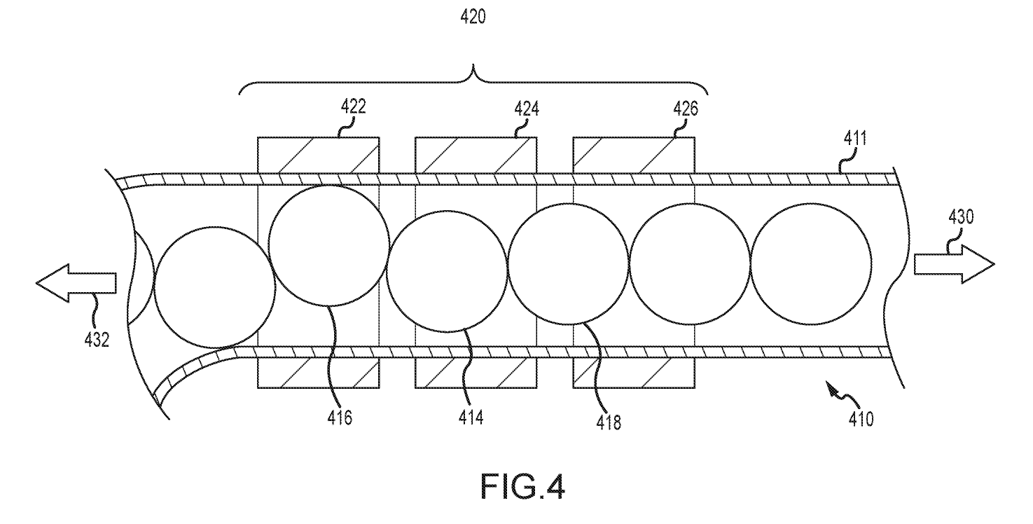

FIG. 4 illustrates a side sectional view of a portion of a transmission system of the present description showing the use of another exemplary drive assembly 420 configured as linear motor. As shown, a length of conduit 410 is provided in which a plurality of balls is positioned including balls 414, 416, and 418. A drive assembly 420 is provided that includes three spaced-apart (but proximally located) coils 422, 424, 426 wrapped about and in contact with the exterior surface 411 of the conduit 410 (with three or more coils typically being desirable). The drive assembly 420 is operable to cause the balls 414, 416, 418 to flow or move in either a first direction 430 or a second direction 432 within the conduit 410. When electricity is sequentially applied to the coils 422, 424, 426 that are placed at specific locations along the outer surface 411 of the tube/conduit 410, the magnetic balls such as ball 414 inside the tube/conduit 410 are accelerated (and moved/flow as shown with arrows 430, 432) without the use of a mechanical device or pump.

Particularly, all the balls including balls 414, 416, 418 may be formed of a magnetic material or may be magnetic balls. While in other cases, spacer balls formed of a non-magnetic material (such as a non-ferrous material such as a plastic or a ceramic) are included with every other ball being magnetic (e.g., ball 414 may be a magnetized ball while balls 416 and 418 are non-ferrous spacers). Such an arrangement may be useful because the axially magnetized magnetic balls (such as ball 414) may be less likely to roll freely (if all balls were magnetic) and will try to orient themselves with their neighbors. The linear motor drive 420 is advantageous in that no mechanical/moving parts are needed. For proper implementation and/or useful operation, the sequence of operation of the coils should be properly controlled and synchronized to move each magnetic ball (including ball 414) through the drive 420, and the coil width relative to the ball OD should be carefully chosen (with greater coil widths being useful to allow the drive 420 to use less voltage (power) to move the balls).

Note, in other embodiments, magnetic balls are used and coils (similar to coils 422, 424, 426) are used to generate electricity as the magnetic fields from the balls move through the coils. In other words, the electricity generator is used as the driven/actuated element 140 of FIG. 1, and a different drive assembly 120 than the one showed in FIG. 4 may be utilized in such a transmission system.

In the same or other embodiments, the drive sensor (e.g., sensor 122 in FIG. 1) is implemented to provide speed and position measurements of the balls in the system. To this end, the speed and position of the balls are measured by use of monitoring coils positioned along the tube (such as similar to coils 422, 424, and 426 of FIG. 4 on conduit 410) and using one or more Hall effect sensors (e.g., with use, in some cases, of magnetic balls such as ball 414 in FIG. 4) in combination with the coils to provide speed and/or position measurements for one or more of the balls.

At this point in the description, it may be useful to provide several examples of drive or actuated elements that may be operated through the selective movement of balls or spherical objects within a conduit. For example, each of these illustrative driven or actuated elements or implementations may be used as element 140 in the system 100 of FIG. 1.

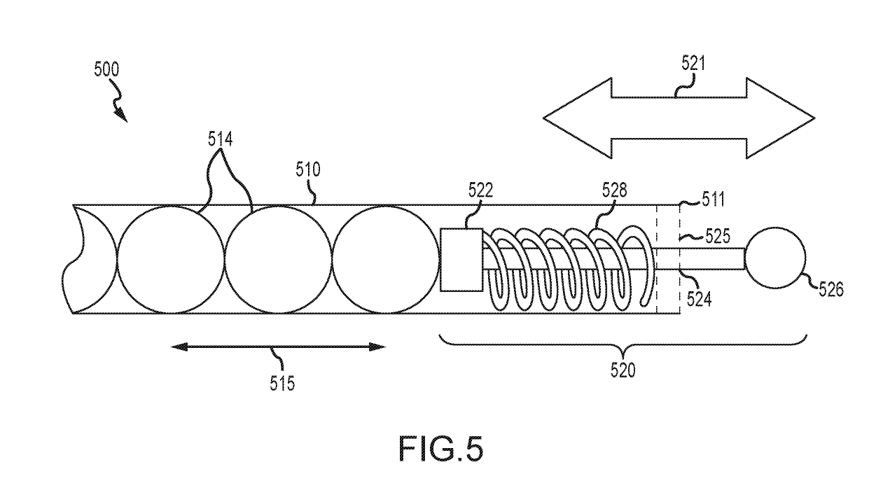

FIG. 5 illustrates a portion of a system 500, such as an implementation of the system 100 of FIG. 1. In this embodiment, the system 500 includes a driven/actuated element 520 in the form of a reversible drive or linear actuator as may be used to drive or actuate a robotic joint or other mechanical element (not shown but readily understood by those in the mechanical arts). In the system 500, a ball pump (such as pump or drive assembly 120 of FIG. 1) is utilized to selectively cause balls/spherical objects 514 within a conduit/tube 510 to move or flow in one of two directions as shown with arrows 515.

The driven/actuated element 520 may be thought of as a linear actuator or, in the illustrated example, a spring-loaded actuator or piston. The driven/actuated element 520 is shown to include a plunger 522, a rod or piston shaft 524 attached at a first end to the plunger 522, and an exposed drive member/coupling element 526 (coupled to the second end of the rod/piston shaft 524) for contacting and/or coupling with a mechanical component (such as a robotic joint) to operate that mechanical component. The rod or piston shaft 524 is aligned or directed in its movements by a hole (with a diameter a small amount larger than an OD of the rod/shaft 524) in an end cap 525 attached to the open end 511 of the conduit 510.

Movement of the driven/actuated element 520 is shown with arrows 521 and is in direct response to movement 515 of the balls/spherical objects 514 in the conduit 510 as the outer-most ball 514 contacts the plunger 522. A spring or other elastic member 528 is provided in the conduit 510 and extends around and along the rod/piston shaft 524 to contact the outer surface of the plunger 522 and the inner surface of the end cap 525 to resist movement by the balls 514 and to assist in returning the actuator 520 to an at-rest or default position. Motion 521, in other words, is created by pushing a piston-type actuator 520 at the end 511 of the conduit/tube 510, thereby compressing the spring 528. Running a ball pump/drive assembly in the system 500 backwards or in the other direction acts to “pull” 515 the balls/spherical objects 514 back out of (or away from) the actuator 520 causing the actuator (or its rod/shaft 524 and end effector 526) 520 to move 521 in the opposite direction or toward the tube/conduit 500 with assistance by the compressed spring 528.

In other embodiments, the driven/actuated element 140 is implemented as a rotary actuator rather than the linear actuator 520 of FIG. 5. Instead of using the balls/spherical objects 514 in the conduit 510 to push a rod/piston shaft 524, the balls 514 in this configuration are used to selective move a screw or gear to convert the linear motion 515 of the balls 514 into a rotation motion (e.g., to actuate a rotary joint of a robot or the like).

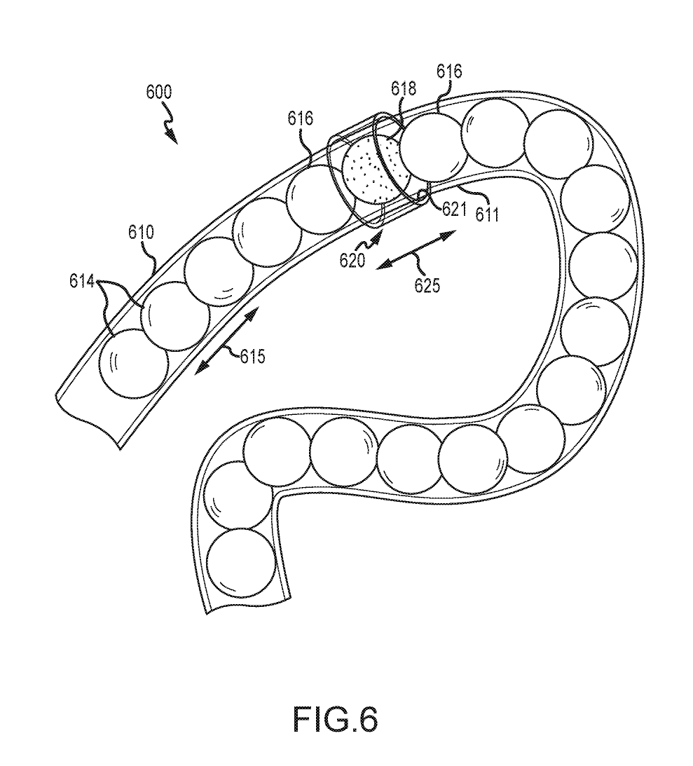

FIG. 6 illustrates a portion of another system 500, e.g., another implementation of the system 100 of FIG. 1, that includes a different embodiment of a driven/actuated element 620 in the form of a linear actuator using magnetic coupling. A plurality of balls/spherical objects 614 are moved (or caused to flow) 615 within a conduit 610, such as by a ball pump/drive assembly (not shown but understood from prior figures and description). The balls 614 may take the form of metal ball bearings.

Magnetic coupling is used in the system 600, and this involves providing a magnetic ball 618 that is, typically but not necessarily, surrounded by a pair (or more) of non-metallic balls 616 in the conduit 610 (e.g., the balls 616 may be glass, plastic, rubber, ceramic, or the like). The conduit 610 is formed of a non-metallic material such as a hard rubber, a plastic, or the like (as discussed above), and a metallic (e.g., ferrous material) collar or ring 620 with an inner diameter some value greater than the OD of the tube 610 is positioned with its inner surface 621 adjacent or surrounding the magnetic ball 618 to move over the outer surface 611 of the conduit/tube 610 (typically without or minimal contact). The movement of the balls 614, 616, and 618 is provided in either direction as shown with arrows 616 by the ball pump/drive assembly (not shown), and the ferrous collar/ring 620 (or driven/actuated element) 620 is forced through its magnetic coupling with the magnetic ball 618 to move 625 with the ball 618. The conduit 610 may have linear runs as shown and/or have curved portions to cause the collar/ring 620 to move along nearly any desired travel path.

As should be clear from FIG. 6, the system 600 uses a ball pump along with the tube/conduit 610 arranged, in this illustration, to have a U-turn in its length to return the balls 614 to the pump. With one magnetic ball 618, an actuator (or magnetic coupler) 620 with a ferrous body or at least inner surface 621 couples magnetically to the magnetic ball 618 and follows its motion 616 as shown with arrows 625. In other embodiments, the ball 618 is formed of a ferrous material (or with a ferrous outer surface/wall) while the collar/ring 620 is fabricated to provide the magnetic field(s) to achieve magnetic coupling between the ball 618 and the actuator 620. The motion of actuation is not restricted to a linear motion and can be curved, and return motion is achieved by running the pump in the opposite or second direction.

The system 600 may be included in a variety of devices/mechanisms. In one embodiment, the system 600 is provided under the skin of an animatronic or robotic or other figure to provide another way to actuate parts of the skin (e.g., to provide a much larger range of motion than before or to provide particular effects such as in a horrific, worms-below-the-skin fashion). In other cases, the system 600 or a modified version of the system 600 may be used to provide a magnetically-coupled animated prop as the driven/actuated element (e.g., element 100 in FIG. 1). In these cases or embodiments, a tube with steel or magnetic balls can be used to power an animated prop by using a magnetic coupling (which may be coupled to collar/ring 620), and this may be used, for example, to give underwater props a defined motion path.

In some embodiments, a non-ball payload may be used as the driven/actuated element 140 of system 100 in FIG. 1. This non-ball payload would be placed in the tube/conduit 610 between two of the balls 614, and, in some systems 600, this non-ball payload, which is configured for rolling or movement within the conduit 610, may carry an electronic device (such as, but not limited to a light (e.g., a light emitting diode (LED)) in a spherical housing), a mating mechanism, and/or a special magnet.

In the same or other embodiments, a large system 600 may be created using a large diameter non-ferrous tube 610 with a combination of ferrous and non-ferrous balls 614, 618 and 616. With the tube 610 embedded in a ride or vehicle track (not shown), a vehicle (not shown) can ride or float (in water) on top, with the vehicle's bogey riding on the track or floating being magnetically coupled to the balls in the tube (e.g., the collar/ring 620 is attached to or coupled to the bogey of the vehicle). An alternative system may be created to increase the magnetic force. This may involve slotting the tube and pushing a magnet “trolley” along the path. The trolley is inserted after the ball pump and removed before reaching or returning to the pump. Another form of the system 600 may not use the magnets/magnetic coupling at all, but it would instead use a catch car inserted into the stream to mechanically pull the vehicle along the travel path defined by the tube/conduit 610.

A magnetically-coupled roller coaster lift hill can be provided using the system 600. In this case, a non-ferrous tube 610 is provided that carries many non-magnetic, non-ferrous balls 614 and 616. The balls 614 and 616 can push 615 a powerful magnet (or train of magnets) 618 (in spherical shape as shown or in other shapes) along inside the tube 610. The magnet train 618, when in a non-ball shape, cannot enter the ball pump/drive assembly (such as assembly 120 in FIG. 1) so the train 618 is returned to the starting position by driving the pump in the reverse or second direction. The cars of the roller coaster are magnetically coupled to the magnet train 618 via a collar/ring 620 or the like that is provided on the lead roller coaster car. This form of lift with system 600 would have advantages over a chain and cable arrangement as the path does not have to be linear but can instead be curved (as shown in FIG. 6 or another curved lift path). One side effect of moving balls such as balls 614 in a tube/conduit 610 is that they will carry some volume of fluid or gas along with them in the tube 610. In some embodiments of the system 600 (or system 100 and other implementations), the driven/actuated element is a fluid/gas (e.g., water) pump as allowing the fluid/gas to enter the tube/conduit 610 causes the system 600 to act as a pump by moving the fluid/gas from its inlet or fluid/gas intake (e.g., perforations a first end of the tube 610 or provided at a first location in the tube/conduit 610) to a fluid/gas outlet (e.g., perforations at a second end of the tube/conduit 610 or the like).

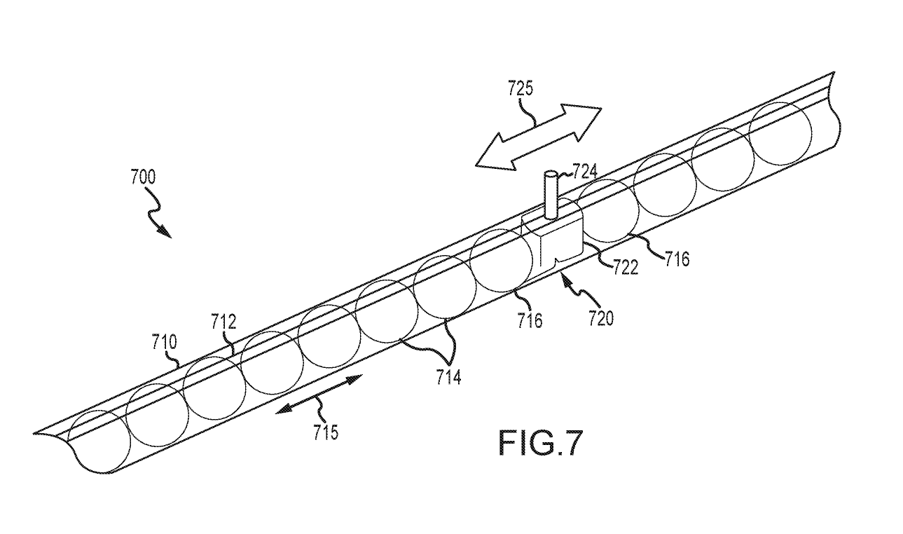

FIG. 7 illustrates a portion of yet another embodiment of a system 700, e.g., another implementation of the system 100 of FIG. 1. The system 700 includes another embodiment of a driven/actuated element 720 in the form of a mechanically-coupled mechanism. As shown, the system 700 includes a tube or conduit 710 that is filled with a plurality of balls/spherical objects 714 that is caused to move or flow in either direction (or first and second opposite directions) within the tube/conduit 710 as shown by arrow 715 by a pump/drive assembly (not shown but may be in the form of assembly 120 of FIG. 1).

The driven/actuated element 720 is positioned in the tube/conduit 710 between a pair of adjacent ones 716 of the balls 714 such that its body 722 (which is sized to fit within the tube/conduit 710) is driven to move with the balls 716 to move with the set of balls 714. The conduit/tube 710 includes a slot 712 in its wall (a slot or groove that provides access to the interior of the tube/conduit 710 but that is relatively narrow and at least with a width less than the OD of the balls 710 to retain the balls 714 in the tube 710), and the slot 712 extends along the conduit's length (parallel to the longitudinal axis of the tube/conduit 710).

The driven/actuated element 720 includes a post or arm 724 that is coupled at a first/inner end to the body/carrier 722 and that extends outward from the tube's slot 712 at a second/outer end, and this outer/second end 724 may be coupled to an object (not shown) to move with the arm/post 724 as shown with arrows 725 with movement 715 of the balls 716 (and 714). For example, the system 700 may be used to provide a mechanically-coupled roller coaster lift hill. The ball bearing-based system 700 is used in a manner similar to how chains are currently used to provide a lift hill. As shown, the slotted tube 710 allows for insertion of a lift mechanism 720 into the stream of balls 714, 716. The tube 710 may also be used as tube 610 is to provide the advantages of curvy paths that may be difficult with a chain drive.

The driven/actuated element 140 in a system such as system 100 of FIG. 1 may also be used for encoding/decoding data. Unlike water or oil, ball bearings and other spherical objects can be easily manipulated in uniform units. The bearings/balls (such as balls 114) may be metal or non-metal and may be magnetic or non-magnetic. This allows for balls of different materials to be loaded into a conduit/tube of a system in a particular or predefined order and delivered to other parts of the system (including a driven/actuated element configured for encoding/decoding data) in that same order. This arrangement of balls and movement of the balls through the conduit may be used in a manner that is similar to a punched computer card and/or automation systems. Instead of holes, each ball can be used to represent a “1” or a “0” depending on whether the ball is metal (e.g., ferrous) or non-metal (e.g., non-ferrous).

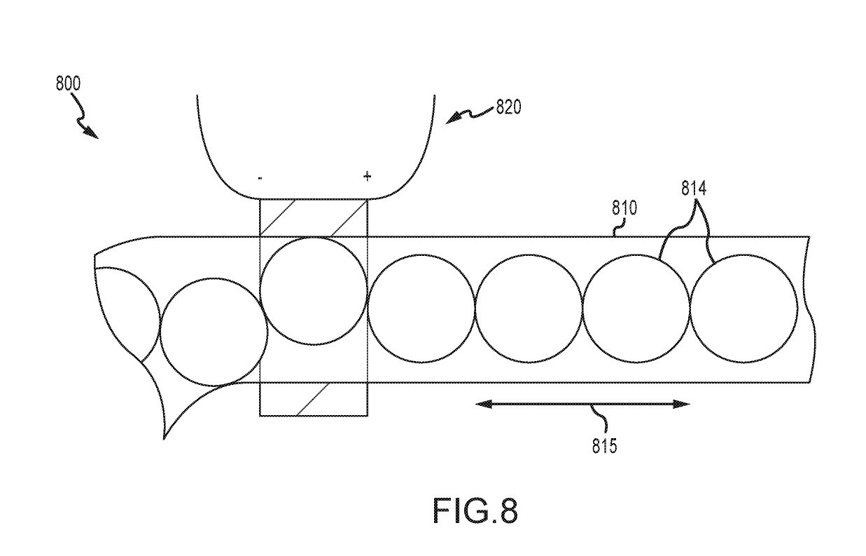

FIG. 8 illustrates a portion of a system 800 with a section of a conduit/tube 810 in which a plurality of balls/spherical objects 814 is contained. A drive assembly (not shown) is used to drive/pump the balls 814 to cause them to move/flow 815 in one of two directions past a driven/actuated element 820. The element 820 is shown to take the form of a coil wrapped around a section of the tube/conduit 810 such that the balls, which are ferrous or non-ferrous and/or magnetic or non-magnetic are caused to flow through the element 820. As discussed, the balls 814 are arranged in a predefined pattern to provide an arrangement of “1s” and “0s.” Reading the data involves placing the coil 820 around a part of the tube 810 and sensing/detecting changes in the current (or changes in the magnetic field) as the balls 814 roll in the tube 810 through the coil/element 820. Multiple tubes 810 may be arranged in parallel to increase the bandwidth of the data encoding/decoding provided by the system 800 during its operations (or with flow 815 of the balls 814).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

As will be appreciated, the new ball-based power transmission system taught herein is useful in place of prior power transmission systems. Air and hydraulic fluid can be difficult to measure, but it is very easy to precisely measure how many ball bearings (exemplary “balls” or spherical objects used in the described systems) are flowing or moving through a transmission line (e.g., a tube). More specifically, air is compressible and difficult to control. Hydraulic oil is easier to control but the valves are expensive, hydraulic systems often leak, and hydraulic systems may require a large pump. Direct actuation requires that the motor be light enough and small enough to be located within the body/object (e.g., the robotic figure) with the actuated element (e.g., a robotic joint).

In contrast, the ball bearing method offers another way to distribute motive power to joints, and it only requires a drive/drive assembly (e.g., a motor and a specially-designed screw pump). As discussed above, there are many applications beyond the robotic joint that can make use of the unique properties of the ball bearing method of motive power transmission. In other words, the actuated/driven element 140 of FIG. 1 may take numerous forms and is not limited to an actuator for a robotic joint. For example, applications that rely on drive chains (e.g., roller coaster lift hills and the like) could be improved with use of the drive systems taught herein in place of (or in addition to) the drive chain. The transmission line used to contain and define the travel path of the balls can be designed to be three-dimensional (3D) whereas a drive chain usually only operates in a two-dimensional (2D) plane.

We claim:

1. A system for transmitting motive force, comprising:
a tube;
a plurality of balls positioned within the tube, wherein each of the balls has an outer diameter less than an inner diameter of the tube;
a drive assembly moving the balls within the tube; and
an actuated element operating to generate an output in response to movement of the balls within the tube,
wherein the actuated element comprises a linear or rotational actuator.

2. The system of claim 1, wherein the actuated element is a linear actuator comprising a plunger contacting one of the balls, a rod attached at a first end to the plunger and with a second end extending out of an end cap affixed to an end of the tube,

3. The system of claim 2, further comprising a spring in the tube extending around the rod between the plunger and the end cap.

4. The system of claim 1, where the balls are disconnected from other ones of the balls to allow unrestrained movement of each of the balls relative to adjacent ones of the balls.

5. The system of claim 1, wherein the balls comprise metal ball bearings and wherein the tubing comprises polyethylene tubing, tubing with a metal lining, or tubing having a hardness greater than a hardness of polyethylene.

6. The system of claim 1, wherein the drive assembly comprises a feed screw driven by a motor to provide positive displacement of the balls through the drive assembly.

7. The system of claim 1, wherein at least a subset of the balls are magnetic spheres and wherein the drive assembly comprises a series of at least three coils wrapped around a section of the tube and a power source sequentially applying electricity to the coils, whereby the drive assembly operates as a linear motor to move the balls in the tube.

8. The system of claim 1, wherein the actuated element includes a magnetic coupler positioned adjacent to one of the balls and wherein the one of the balls and the magnetic coupler are magnetically coupled, whereby the magnetic coupler moves along an outer surface of the tube when the one of the balls is moved within the tube.

9. The system of claim 8, wherein the one of the balls comprises a magnetic sphere and the magnetic coupler includes a ferrous ring extending about a periphery of the tube.

10. The system of claim 9, wherein the balls on opposite sides of the one of the balls is non-magnetic or non-ferrous.

11. A system for transmitting motive force, comprising:
a conduit;
a plurality of spherically-shaped objects positioned within the conduit, wherein each of the spherically-shaped objects has an outer diameter less than an inner diameter of the conduit;
a drive assembly moving the spherically-shaped objects within the conduit;
a controller operating the drive assembly to provide movement of the spherically-shaped objects at a predefined rate; and
a linear actuator actuated by movement of the spherically-shaped objects, wherein the linear actuator is positioned at an end of the conduit.

12. The system of claim 11, wherein the linear actuator comprises a plunger contacting one of the spherically-shaped objects and a rod attached at a first end to the plunger and with a second end extending out of an end cap affixed to an end of the conduit.

13. The system of claim 12, wherein the linear actuator further comprises a spring member in the conduit extending around the rod between the plunger and the end cap.

14. The system of claim 11, wherein the conduit has an interior space defining a three-dimensional (3D) travel path and the spherically shaped objects are positioned within the interior space.

15. The system of claim 11, wherein the drive assembly comprises a feed screw driven by a motor to provide positive displacement of the spherically-shaped objects through the drive assembly.

16. The system of claim 11, further comprising an actuated element including a magnetic coupler positioned adjacent to one of the spherically-shaped objects and wherein the one of the spherically-shaped objects and the magnetic coupler are magnetically coupled, whereby the magnetic coupler moves along an outer surface of the conduit when the one of the spherically-shaped objects is moved within the conduit.

17. The system of claim 11, wherein the conduit comprises a slot, wherein the slot extends parallel to a longitudinal axis of the conduit, and wherein the system includes an actuated element comprising a body positioned between an adjacent pair of the spherically-shaped objects within the conduit and an arm attached at a first end to the body and extending through the slot, whereby objects coupled to the second end of the arm move along the conduit with movement of the spherically-shaped objects.

18. A system for transmitting motive force, comprising:
a tube;
a plurality of balls positioned within the tube;
a drive assembly operable to move the balls within the tube at one or more predefined rates and in a switchable manner in both directions; and
an actuated element actuated by movement of the balls within the tube,
wherein the actuated element is a linear actuator comprising a plunger contacting one of the balls and further comprising a rod attached at a first end to the plunger.

19. The system of claim 18, wherein a second end of the rod extends out of an end cap affixed to an end of the tube.

20. The system of claim 19, wherein the linear actuator further comprises a spring in the tube extending around the rod between the plunger and the end cap.
